(19) United States
(12) Patent Application Publication
(10) Pub. No.: US 2010/0323554 A1
(43) Pub. Date: Dec. 23, 2010

(54) Connector structure

(75) Inventor: Kuang-Hua Shiu, Hukou Township (TW)

Correspondence Address: Muncy, Geissler, Olds & Lowe, PLLC, 4000 Legato Road, Suite 310, FAIRFAX, VA, 22033, US

(73) Assignee: Singatron Enterprise Co., Ltd.

(21) Appl. No.: 11/892,998

(22) Filed: Aug. 29, 2007

(51) Int. Cl. H01R 3/00; H01R 24/00

(52) U.S. Cl. 439/490; 439/660

(57) ABSTRACT

The present invention provides a connector structure, in which a connector is structured from a housing, a base and terminals, and the base and a plurality of the terminals are embedded in the housing. The base is structured from a first base and a second base, wherein the first base is internally configured with a plurality of ribs corresponding to first terminals. Accordingly, when the first terminals are assembled within the first base, a plurality of guide grooves of the first terminals accommodate the plurality of ribs within the first base, thus causing the guide grooves to extend over the ribs and become disposed within the first base, moreover, in conjunction with clasping of the second base, strengthening fixture of the first terminals, thereby preventing the first terminals from falling off due to frequent unplugging and plugging of the connector for a long period of time.

### BACKGROUND OF THE INVENTION

(a) Field of the Invention

The art of the present invention provides an improved connector structure, and more particularly provides functional coordination between a plurality of ribs of a first base and a second base.

(b) Description of the Prior Art

The terminals of conventional connectors of prior art are clasped within a base, and punch formed spring pieces located or a barbed structure on the terminals is used to strengthen clasping to the base. However, use of the barbed structure on the terminals results in loosening of the terminals after long term friction between the barbs on the terminals and the base, and use of the spring piece structure on the terminals easily results in incomplete punch forming of the spring piece on the terminals during the punch forming process, thereby preventing the spring pieces from being able to be securely fixed to the base. Moreover, use of the spring pieces to clasp the terminals to the base, results in loosening of the spring pieces after long term usage, thereby causing inconvenience of use.

Hence, the inventor of the present invention proposes to resolve and surmount existent technical difficulties to eliminate the aforementioned shortcomings of prior art.

### SUMMARY OF THE INVENTION

The art of the present invention provides an improved connector structure, and more particularly provides functional coordination between a plurality of ribs of a first base and a second base, thereby strengthening fixture of first terminals to a connector.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of the present invention.

FIG. 2 shows an exploded elevational view of the present invention.

FIG. 3 shows a first elevational view of an embodiment of the present invention.

FIG. 4 shows a second elevational view of the embodiment of the present invention.

FIG. 5 shows a third elevational view of the embodiment of the present invention.

FIG. 6 shows a fourth elevational view of the embodiment of the present invention.

### DETAILED DESCRIPTION OF THE PREFERRED EMBODIMENTS

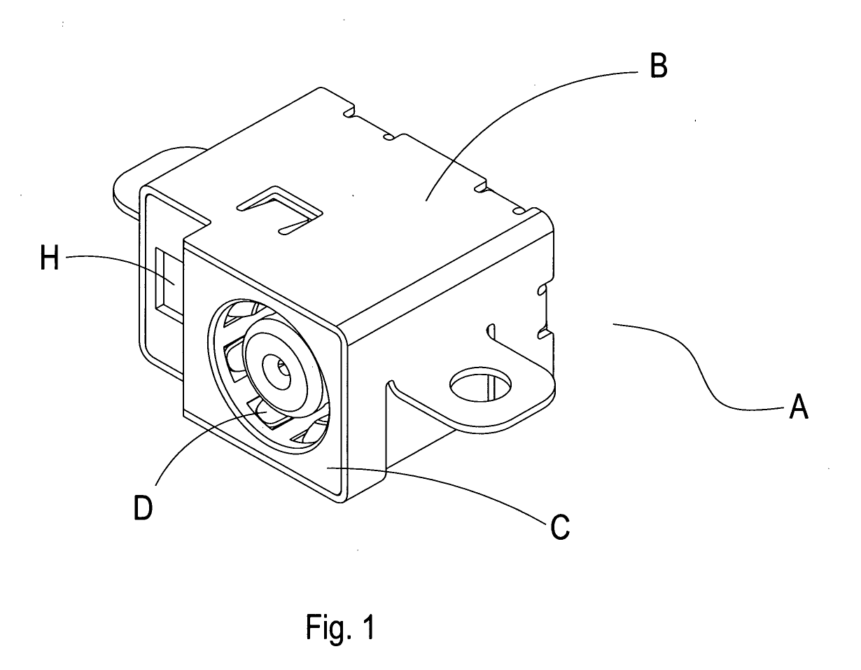

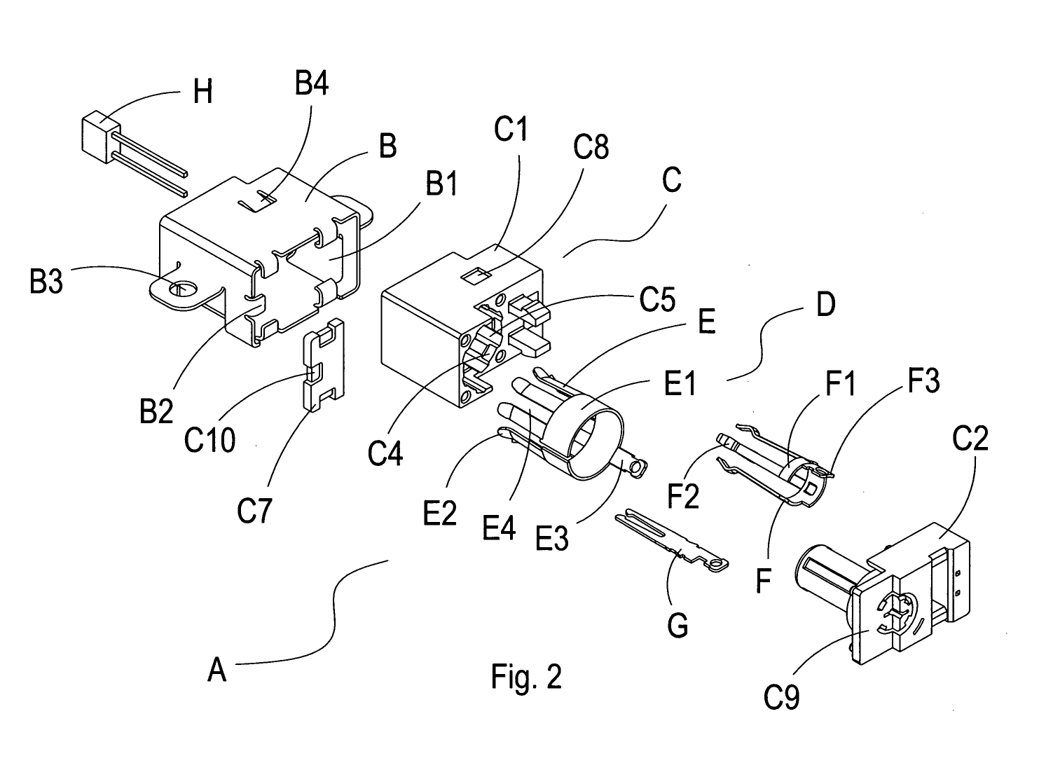

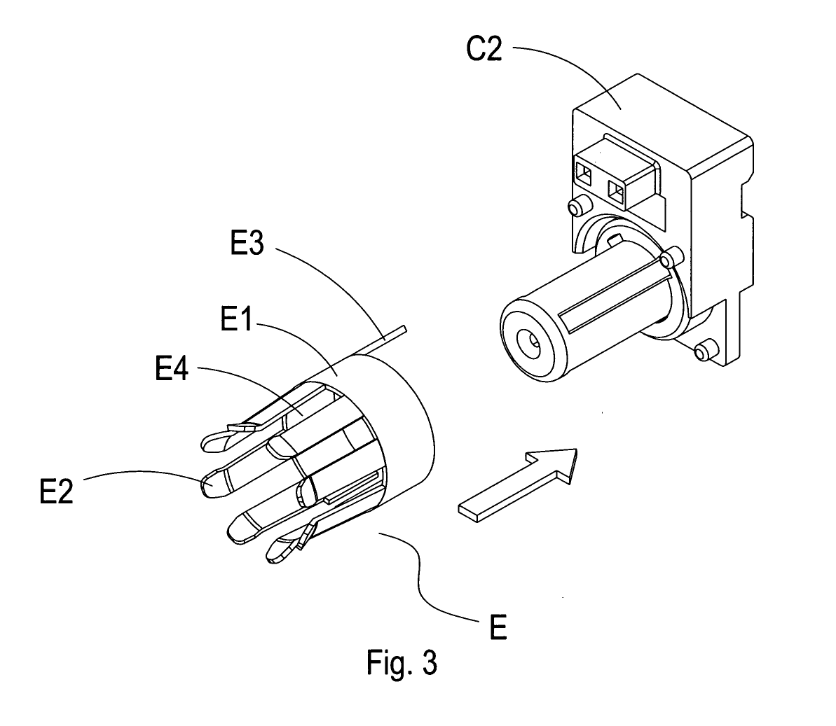

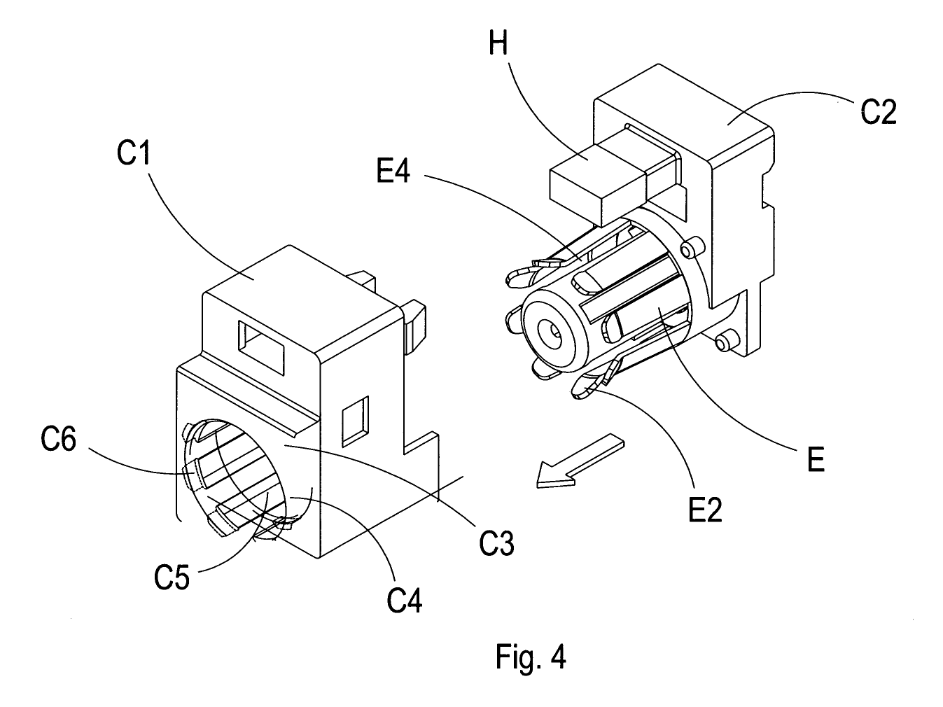

The present invention provides an improved connector structure, as depicted in FIG. 1, FIG. 2, FIG. 3 and FIG. 4, wherein a connector A is structured to comprise a housing B, a base C and terminals D.

The interior of the housing B of the connector A is provided with a holding cavity B1, and areas of the housing B of the connector A are configured with a plurality of abutting pieces B2 and a plurality of holes B3, and other areas of the housing B of the connector A are provided with clasp pieces B4. A base C and the plurality of terminals D are clasped within the holding cavity B1 of the housing B. The base C of the connector A comprises a first base C1 and a second base C2, in which the first base C1 of the base C is configured with a holding space C3. The holding space C3 of the first base C1 is configured with a plurality of ribs C4 and a plurality of holddown grooves C5, in which grooves C6 extend from ends of the holddown grooves C5 of the holding space C3 and enable first contact ends E2 of first terminals E to be disposed therein. Moreover, fixing holes C8 are defined at areas of the first base C1, and a light-emitting element H is configured in the first base C1 of the base C. Furthermore, an area of the second base C2 of the base C is provided with a recess C9 and a clasp piece C7 corresponding to the recess C9, wherein the clasp piece C7 is provided with a plurality of embedding portions C10. The clasp piece C7 of the connector A enables press fitting of second terminals F of the terminals D to achieve the objective of secure fixing thereof.

Furthermore, the terminals D of the connector A comprise the first terminals E, the second terminals F and signal terminals G, wherein the first terminals E of the terminals D are configured with a first main body E1. A plurality of first contact ends E2 extend from the first main body E1 of the first terminals E, and a plurality of guide grooves E4 are formed between the plurality of first contact ends E2 of the first terminals E. Moreover, a first soldering end E3 extends from another end of the first main body E1. Furthermore, the second terminals F of the terminals D are configured with a second main body F1, and second contact ends F2 extend from the second main body F1 of the second terminals F, in addition, a second soldering terminal F3 extends from the second main body F1.

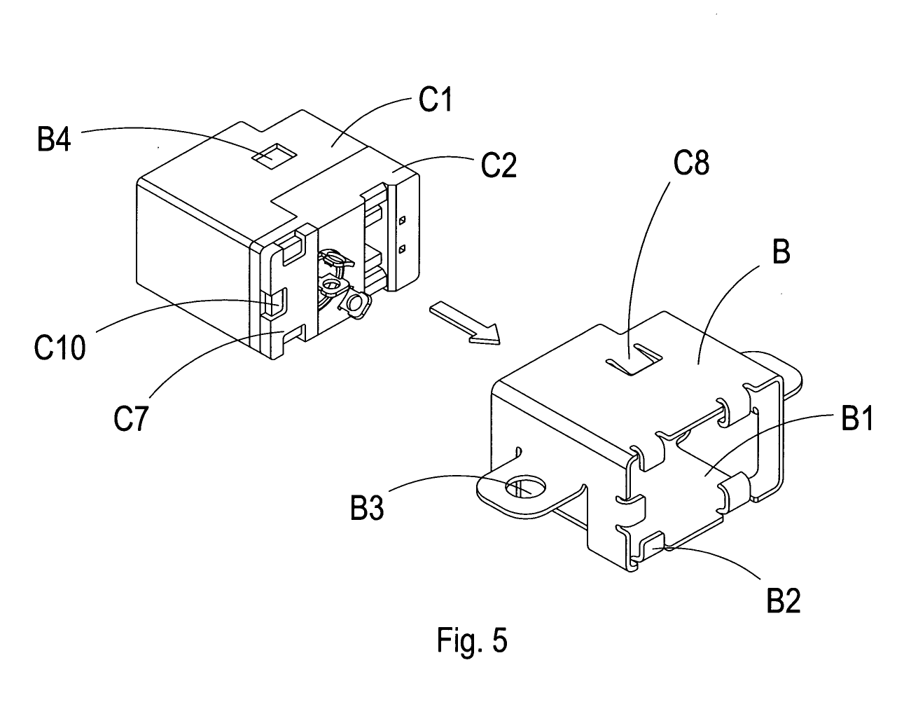

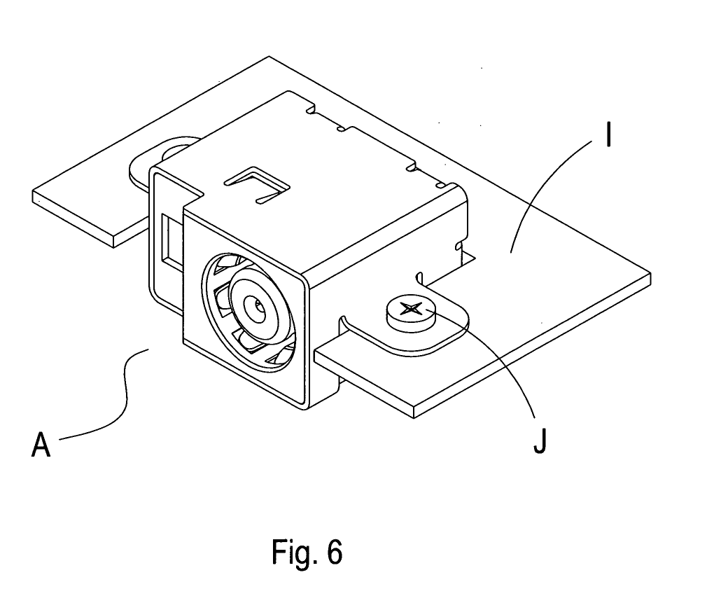

An embodiment of the improved connector structure provided by the present invention, as depicted in FIG. 1, FIG. 2, FIG. 3 and FIG. 4, FIG. 5 and FIG. 6, comprises the base C of the connector A configured with the first base C1 and the second base C2, and the interior the first base C1 of the base C is provided with the holding space C3. The holding space C3 of the first base C1 is configured with the plurality of ribs C4 and the plurality of holddown grooves C5. Moreover, the plurality of grooves C6 extend from the ends of the holddown grooves C5 of the first base C1, thereby enabling the first terminals E of the terminals D to be disposed on the second base C2 during assembly thereof, after which the already assembled second base C2 of the first terminals E is further assembled to the first base C1, whereupon the guide grooves E4 of the first terminals E accommodate the ribs C4 of the holding space C3, at the same time the first contact ends E2 of the first terminals E are accommodated by the holddown grooves C5 of the holding space C3, thereby enabling the first terminals E of the terminals D to extend into and be disposed within the holding space C3 of the first base C1. Accordingly, when assembling the first terminals E of the terminals D within the holding space C3 of the first base C1, the first contact ends E2 of the first terminal E are able to extend and be disposed within the grooves C6 of the first base C1, thereby preventing the first contact ends E2 of the first terminals E from upturning after long term usage. Furthermore, use of the clasping of the second base C2 in conjunction with the aforementioned configuration further strengthens fixture of the first terminals E, thereby preventing the first terminals E of the terminals D from falling off due to frequent unplugging and plugging of the connector A for a long period of time.

When assembling the connector A, the first terminals E of the terminals D and the light-emitting element H of the connector A are first assembled to the second base C2 of the base C, after which the second base C2 having already assembled the first terminals E and the light-emitting element H thereto is assembled within the first base C1 of the base C, thereby causing the first terminals E of the terminals D to be disposed within the holding space C3 of the first base C1. The second terminals F and the signal terminals G of the terminal D are then inserted into the second base C2, and the clasp piece C7 of the connector A is pressed into the recess C9 of the second base C2, after which the base C1 of the connector A is assembled within the housing B of the connector A, at which time, the clasp pieces B4 of the housing B are clasped within the fixing holes C8 of the first base C1, whereupon the abutting pieces B2 of the housing B abut against the embedding portions C10 of the clasp piece C7, and screw members J are then made to respectively penetrate the holes B3 of the housing B, and screwed tight to a circuit board I.

The first main body E1, the first contact ends E2 and the first soldering end E3 of the first terminals E and the second main body F1, the second contact ends F2 and the second soldering end F3 of the second terminals F are formed as integrated bodies, thereby achieving the objective of convenient assembly of the base C of the connector A. Moreover, the signal terminals G of the terminals D enables the connector A to transmit signals, and the light-emitting element H of the connector A is used to achieve the objective of determining whether or not the connector A is conducting electricity.

In order to better explicitly disclose advancement and practicability of the present invention, a comparison with prior art is described hereinafter:

### SHORTCOMINGS OF PRIOR ART

1. A barbed structure or a spring piece structure is located on the terminals to strengthen fixture within a base.

2. Because of shortcoming 1, long-term friction from the barbed terminal structure easily results in loosening of the terminals.

3. Because of shortcoming 1, when a spring piece terminal structure is used, incomplete punch forming of the spring pieces easily results when punch forming the spring pieces, thus, the spring pieces are unable to be securely fixed to the base.

4. Because of shortcoming 3, when spring pieces are used to clasp the terminals to the base, then loosening of the spring pieces easily results after long term usage.

5. Creates inconvenience of use.

### ADVANTAGES OF THE PRESENT INVENTION

1. The structure is provided with the ribs C4 located within the holding space C3 of the first base C1 corresponding to the guide grooves E4.

2. Because of shortcoming 1, thus, long term usage does not cause shifting and loosening of the first terminals E.

3. The structure is provided with the plurality of grooves C6 defined interior of the holding space C3 of the first base C1.

4. Because of shortcoming 3, thus, when assembling the first terminals E within the first base C1, the first contact ends E2 can be disposed within the grooves C6.

5. Because of shortcoming 4, thus, the present invention is able to achieve the objective of preventing upturning of the first contact ends E2 after long term usage of the first terminals E.

6. Provided with advancement and practicability.

7. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A connector structure, comprising:
a housing provided with a holding cavity, in which a base and terminals are disposed for use thereof, and areas of the housing are configured with a plurality of abutting pieces and a plurality of holes;
the base, comprising a first base and a second base mutually clasped together, wherein the first base is configured with a holding space, and a plurality of ribs and a plurality of holddown grooves are located interior of the holding space, moreover, another area of the second base is provided with a recess and a clasp piece corresponding to the recess, and a plurality of corresponding terminals are configured interior of the first base and the second base, the terminals are used to achieve the objectives of electric conductance and signal transmission; and
the terminals comprise first terminals, second terminals and signal terminals, wherein the first terminals are configured with a first main body; first contact ends extend from the first main body, a plurality of guide grooves are formed between the plurality of first contact ends, and a first soldering end extends from another end of the first main body; the second terminals are configured with a second main body, second contact ends extend from the second main body, and a second soldering terminal extends from the second main body;
when the first terminals are assembled within the first base, the plurality of guide grooves of the first terminals accommodate the plurality of ribs within the first base, thereby causing the guide grooves to extend over the ribs and become clasped within the first base, and, in conjunction with clasping of the second base, enables strengthening fixture of the first terminals, thereby preventing the first terminals from falling off due to frequent unplugging and plugging of the connector for a long period of time.

2. The connector structure according to claim 1, wherein grooves extend from ends of the holddown grooves of the first base, and when the first terminals are assembled within the first base, the plurality of first contact ends extend and are disposed within the holddown grooves, thereby preventing the first contact ends from upturning after long term usage of the first terminals.

3. The connector structure according to claim 1, wherein the first main body, the first contact ends and the first soldering end of the first terminals and the second main body, the second contact ends and the second soldering end of the second terminals are formed as integrated bodies, thereby achieving the objective of convenient assembly.

4. The connector structure according to claim 1, wherein the signal terminals are used to enable the connector to transmit signals.

5. The connector structure according to claim 1, wherein an area of the base is configured with a light-emitting element, which is used to determine whether or not the connector is conducting electricity.

6. The connector structure according to claim 1, wherein symmetrically corresponding clasp pieces are located at areas of the housing, and symmetrically corresponding fixing holes are defined at areas of the first base; the clasp pieces are used to clasp into the fixing holes, thereby fixedly clasping the base within the housing.
